(19) United States
(12) Patent Application Publication
(10) Pub. No.: US 2024/0411100 A1
(43) Pub. Date: Dec. 12, 2024

(54) CABLE ENTRY TRANSITION TO A CASSETTE FOR A FIBER OPTIC CABLE CONFIGURED TO REDUCE STRESS ON AN OPTICAL FIBER AND REDUCE SIGNAL LOSS

(71) Applicant: BELDEN CANADA ULC, SAINT-LAURENT (CA)

(72) Inventor: MOSES LEVY, Laval (CA)

(73) Assignee: BELDEN CANADA ULC, SAINT-LAURENT (CA)

(21) Appl. No.: 18/736,672

(22) Filed: Jun. 7, 2024

Related U.S. Application Data
(60) Provisional application No. 63/472,394, filed on Jun. 12, 2023.

(51) Int. Cl. G02B 6/44

(52) U.S. Cl. CPC G02B 6/4478; G02B 6/44528

(57) ABSTRACT

A cable entry transition to a cassette for a fiber optic cable that is configured to reduce stress on an optical fiber and reduce signal loss includes: a body that is configured to receive a cable; a retaining portion that is configured to engage a receiving portion of a cassette; a strength member securing portion; and a guide configured to connect to the body. The strength member securing portion is configured to secure a strength member of the cable to the body; and the cable entry transition portion is structurally configured to mechanically secure the strength member of the cable to a cassette such that a pulling force exerted on the cable is prevented from being transmitted to an optical fiber in the cable and the optical fiber is permitted to pass through the cassette so as to reduce signal loss of the system.

### CROSS-REFERENCE TO RELATED APPLICATION

This application claims the benefit of U.S. Provisional Application No. 63/472,394 filed Jun. 12, 2023, which is currently pending, the disclosure of which is hereby incorporated by reference herein in its entirety.

### BACKGROUND

The present disclosure relates generally to telecommunications systems and, in particular, to an entry transition for use with telecommunications cassettes configured to receive a multi-fiber push on adapter.

Fiber optic cable assemblies may come with fiber optic connectors pre-terminated on at least one end of the cable assembly. In these cases, the installer then needs to individually connect each connector to a patch panel or to the back of pre-terminated multi-fiber push on (MPO) cassettes. Installers are also able to obtain fiber optic cable assemblies that are pre-terminated with a loaded cassette instead of individual fiber optic connectors. The installer then just needs to place the pre-terminated cassettes in the patch panel without making any optical connections. These cassettes are usually bigger and longer than the standard pre-terminated cassettes with MPO connectors at the back.

It may be desirable to provide smaller, more compact, pre-terminated cassettes directly on the pre-terminated cable assemblies. It may be desirable for the cable entry point to these cassettes to have the same footprint as the standard MPO adapter. It may be desirable for this entry point to have a mechanical anchor point for the cable as well as a proper bend limiter to avoid degrading the optical performance.

### SUMMARY

The present disclosure provides a much needed system for providing a cable entry transition for a fiber optic cassette that mechanically secures a strength member in the cable to the cassette to prevent a pulling force exerted on a cable entering the cassette from being transmitted to the optical fiber in the cable while allowing the optical fiber to pass through the cassette without using a multi-fiber push on adapter, thereby eliminating a multi-fiber push on connection point, reducing the overall loss of the system.

Embodiments provide a cable entry transition to a cassette for a fiber optic cable that is configured to reduce stress on an optical fiber and reduce signal loss comprising: a cable that may comprise an optical fiber portion; and a cable entry transition portion that may comprise a body portion that may be configured to receive the cable, a retaining portion that may be configured to engage a receiving portion of a cassette, a strength member securing portion, a guide portion that may be configured to connect to the body portion, and a bend-limiting portion that may be structurally configured to limit a bend angle of the cable. The cable may comprise a strength member portion; the strength member securing portion may be configured to secure the strength member portion to the body portion; the guide portion may comprise a through hole that may be configured to receive the optical fiber portion such that the optical fiber portion passes through the guide portion intact; and the cable entry transition portion may be structurally configured to mechanically secure the strength member portion of the cable to a cassette such that a pulling force exerted on the cable is prevented from being transmitted to the optical fiber portion of the cable and the optical fiber portion is allowed to pass through the cassette without using a multi-fiber push-on adapter so as to eliminate a multi-fiber push-on connection point and reduce signal loss of the system.

In various embodiments, the optical fiber may be a first optical fiber, and the cable may further comprise a plurality of optical fibers.

In various embodiments, the cable entry transition portion may be structurally configured to mechanically secure the strength member in the cable to a cassette that may be configured to receive an adapter.

In various embodiments, the optical fiber may be a first optical fiber, and the cable may further comprise a second optical fiber; the first optical fiber may be configured to extend from the cable to the adapter; and the second optical fiber may be configured to extend through the cassette and exist the cassette.

In various embodiments, the guide portion may be structurally configured to receive a furcation tube, wherein the furcation tube may be configured to receive the optical fiber such that the optical fiber passes through the furcation tube.

In various embodiments, the strength member may comprise a strength material.

In various embodiments, the strength material may be Kevlar.

In various embodiments, the retaining portion may comprise two flanges that may extend laterally from a central portion of the body portion.

In various embodiments, the receiving portion of the cassette may be an opening.

In various embodiments, the body portion, the retaining portion, the strength member securing portion, the retainer portion, and the bend-limiting portion may be a homogeneously formed unit.

In various embodiments, the cable entry transition may be structurally configured to be received in the receiving portion of the cassette that may be structurally configured to receive a standard multi-fiber push-on adapter.

Embodiments provide a cable entry transition to a cassette for a fiber optic cable that is configured to reduce stress on an optical fiber and reduce signal loss including: a body portion that may be configured to receive a cable; a retaining portion that may be configured to engage a receiving portion of a cassette; a strength member securing portion; and a guide portion that may be configured to connect to the body portion. The cable may comprise an optical fiber portion and a strength member portion; the strength member securing portion may be configured to secure the strength member portion to the body portion; the guide portion may comprise a through hole that may be configured to receive the optical fiber portion such that the optical fiber portion passes through the guide portion intact; and the cable entry transition portion may be structurally configured to mechanically secure the strength member portion of the cable to a cassette such that a pulling force exerted on the cable is prevented from being transmitted to the optical fiber portion of the cable and the optical fiber portion is permitted to pass through the cassette without using a multi-fiber push-on adapter so as to eliminate a multi-fiber push-on connection point and reduce signal loss of the system.

In various embodiments, the cable entry transition portion may be structurally configured to mechanically secure the strength member in the cable to a cassette that may be configured to receive an adapter.

In various embodiments, the guide portion may be structurally configured to receive a furcation tube, wherein the furcation tube may be configured to receive the optical fiber such that the optical fiber passes through the furcation tube.

In various embodiments, the retaining portion may comprise two flanges that may extend laterally from a central portion of the body portion.

In various embodiments, the cable entry transition portion my further comprise a bend-limiting portion that may be structurally configured to limit a bend angle of the cable.

In various embodiments, the cable entry transition may be structurally configured to be received in the receiving portion of the cassette that may be structurally configured to receive a standard multi-fiber push-on adapter.

Embodiments provide a cable entry transition portion to a cassette for a fiber optic cable that is configured to reduce stress on an optical fiber and reduce signal loss including: a body portion that may be configured to receive a cable; a retaining portion that may be configured to engage a receiving portion of a cassette; a strength member securing portion; and a guide portion that may be configured to connect to the body portion. The strength member securing portion may be configured to secure a strength member portion of the cable to the body portion; and the cable entry transition portion may be structurally configured to mechanically secure the strength member portion of the cable to a cassette such that a pulling force exerted on the cable is prevented from being transmitted to an optical fiber portion in the cable and the optical fiber portion is permitted to pass through the cassette so as to reduce signal loss of the system.

In various embodiments, the guide portion my comprise a through hole configured to receive the optical fiber such that the optical fiber passes through the guide portion intact.

In various embodiments, the cable entry transition portion may further comprise a bend-limiting portion that may be structurally configured to limit a bend angle of the cable.

In various embodiments, the cable entry transition portion may be structurally configured to mechanically secure the strength member in the cable to the cassette to prevent a pulling force exerted on the cable from being transmitted to an optical fiber in the cable while allowing the optical fiber to pass through the cassette, without using a multi-fiber push on adapter, thereby eliminating a multi-fiber push on connection point.

In various embodiments, the cable entry transition portion may be structurally configured to mechanically secure the strength member in the cable to a cassette that may be configured to receive an adapter.

In various embodiments, the guide portion may be structurally configured to receive a furcation tube, wherein the furcation tube may be configured to receive the optical fiber such that the optical fiber passes through the furcation tube.

In various embodiments, the retaining portion may comprise two flanges that may extend laterally from a central portion of the body portion.

In various embodiments, the cable entry transition portion may be structurally configured to be received in the receiving portion of the cassette that may be structurally configured to receive a standard multi-fiber push-on adapter.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a top view of a cassette and a first embodiment of a cable entry transition in accordance with various aspects of the disclosure.

FIG. 2 is a perspective view of the cassette and cable entry transition of FIG. 1 with a top cover removed.

FIG. 3 is a top view of the cassette and cable entry transition of FIG. 1 with the top cover removed and internal cables installed.

FIG. 4 is a view of the cable entry transition of FIG. 1 and an associated cable.

FIG. 5 is a view of the cable entry transition of FIG. 4 and the associated cable.

FIG. 6 is a perspective view of the cable entry transition of FIG. 4 and the associated cable.

FIG. 7 is a perspective view of a cassette and a second embodiment of a cable entry transition in accordance with various aspects of the disclosure.

FIG. 8 is a perspective view of the cassette and cable entry transition of FIG. 7 with a top cover removed.

FIG. 9 is a top view of the cassette and cable entry transition of FIG. 7 with the top cover removed and internal cables installed.

FIG. 10 is a perspective view of the cable entry transition of FIG. 7.

FIG. 11 is a view of a cable prepared for formation of the cable entry transition of FIG. 10.

FIG. 12 is a view of the cable of FIG. 11 placed in a mold in preparation for formation of the cable entry transition of FIG. 10.

FIG. 13 is a view of the cable entry transition of FIG. 10 formed around the cable of FIG. 11.

### DETAILED DESCRIPTION OF EMBODIMENTS

Embodiments of the disclosure provide a cable entry transition portion that is structurally configured to mechanically secure a strength member portion of a cable to a cassette such that a pulling force exerted on the cable is prevented from being transmitted to an optical fiber portion of the cable and the optical fiber portion is allowed to pass through the cassette without using a multi-fiber push-on adapter so as to eliminate a multi-fiber push-on connection point and reduce signal loss of the system.

An aspect of the disclosure is to be able to use a smaller, more compact, pre-terminated fiber cassette directly on a pre-terminated cable assembly. In embodiments, the cable entry transition to these cassettes have the same footprint as a standard MPO adapter. In embodiments, this cable entry transition has a mechanical anchor point for the cable as well as a proper bend limiter to avoid degradation of optical performance.

Embodiments provide a special cable entry transition between a fiber optic cable sub-unit to the individual fibers (for example, 900 μm fibers) in the cassette that are terminated with optical connectors. In embodiments, the cable entry transition includes several parts that are assembled, including a mechanical crimp and a flexible boot. In embodiments, the shape of the cable entry transition is such that it replaces an MPO adapter at the back of a standard pre-terminated MPO cassettes module.

In embodiments, the cable entry transition mechanically secures the Kevlar (or other) strength member from the optic cable sub-unit to create a secure anchor point to the cassette. In embodiments, the cable entry transition also includes a bend limiter to ensure that the optical signal will not be attenuated by excessive bending.

In embodiments, the cable entry transition is compatible with a standard MPO adapter foot-print, may be used in any cassette or module that can accept a similar adapter, securely anchors the optic fiber sub-unit to protect the fibers, protects the optic fiber sub-unit from excessive bending, and/or eliminates one MPO connection point.

In embodiments, the cable entry transition is molded onto the fiber optic cable sub-unit using low pressure molding (LPM) in order to transition to the individual fibers (for example, 900 μm fibers) that are terminated with optical connectors. In embodiments, the shape of the LPM cable entry transition point is such that it replaces the MPO adapter or other adapter footprint at the back of a standard pre-terminated MPO cassettes module.

In embodiments, the LPM cable entry transition mechanically secures the Kevlar (or other) strength member from the optic cable sub-unit to create a secure anchor point to the cassette. In embodiments, the LPM cable entry transition also includes a bend limiter to ensure that the optical signal will not be attenuated by excessive bending. In embodiments, the LPM cable entry transition may be included as an integral part of a module.

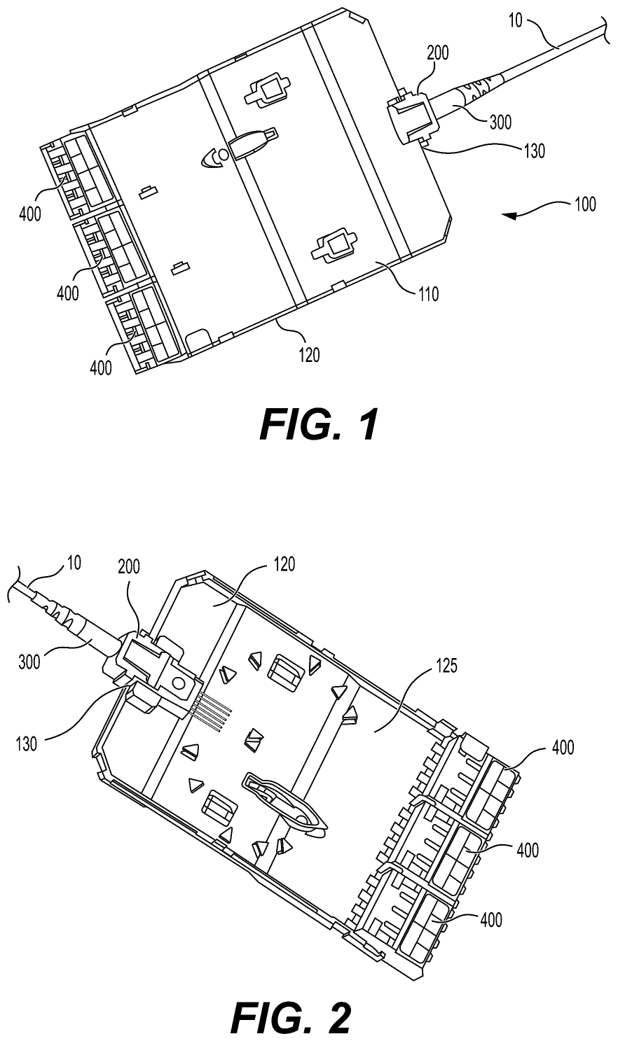

FIGS. 1 and 2 show an exemplary cassette 100 having a cassette base portion, for example, a cassette base, 120 and a cassette cover portion, for example, a cassette cover, 110 that, in this example, snaps onto the cassette base 120 to cover an internal area 125 of the cassette base 120. In this example, three adapter portions, for example, adapters, 400 are located partially inside the cassette 100 and extend out of the cassette 100 at one end of the cassette 100. Other examples have fewer or more adapter portions. In this example, each of the adapters 400 is configured to receive four connectors that each connect one or more optical fibers to the adapter 400. Other examples include one or more adapters that are configured to receive fewer or more than four connectors. FIGS. 1 and 2 show a cable 10 attached to the cassette 100 by way of a cable entry transition portion, for example, a cable entry transition, 200 at a transition portion receiving portion, for example, an opening, 130 located at an end of the cassette 100 that is opposite to the end of the cassette 100 where the adapters 400 are located. A non-limiting example of the cable 10 is a 144 fiber cable containing 144 optical fibers. The cable 10 includes one or more optical fibers 12 (see FIG. 4). In this example, a bend-limiting strain relief portion, for example, a boot, 300 is located around the cable 10 where the cable 10 attaches to the cable entry transition 200 to limit bending of the cable 10 so as to prevent degradation of the optical signals transmitted in the cable 10.

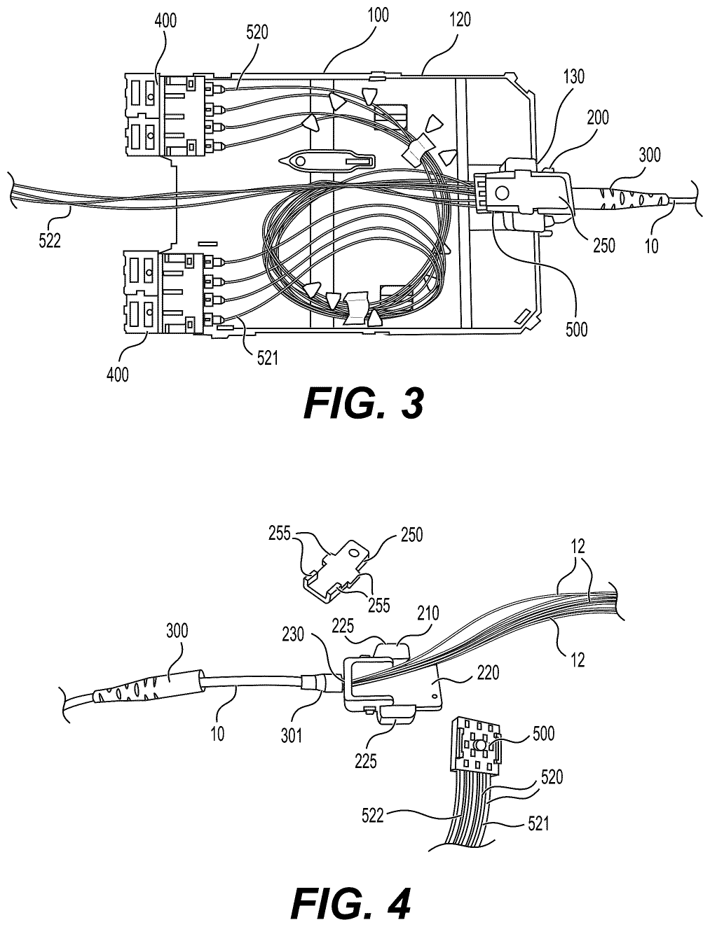

FIG. 3 shows an example of the cassette 100 that has the cable 10 entering the right side of the figure and containing a number of optical fibers. The optical fibers in this example include three groups of fibers that pass through a guide portion, for example, a guide, 500 that is attached to the cable entry transition 200 (also see FIG. 4). A first group of the optical fibers (in this example shown in furcation tubes 520) are connected to a first one of the adapters 400, a second group of the optical fibers (in this example shown in furcation tubes 521) are connected to a second one of the adapters 400, and a third group of the optical fibers (in this example shown in furcation tubes 522) pass through the cassette 100. In other examples, zero, one, or more groups of the fibers pass through the cassette 100 without being connected to an adapter 400.

FIG. 4 shows the cable entry transition 200 in a disassembled state in which a cable entry transition cover portion, for example a cable entry transition cover, 250 is shown removed from a cable entry transition body portion, for example, a cable entry transition body, 210 of the cable entry transition 200. In embodiments, the cable entry transition body 210 is configured to be received in a receptacle on the cassette 100 that is configured to receive, for example, a standard MPO adapter. In this example, the cable entry transition body 210 of the cable entry transition 200 has a receiving portion 220 that is configured to receive the guide 500. In this example, the cable entry transition body 210 has a retaining portion, for example, two retaining portions, for example, flanges, 225 that extend laterally from a central portion of the cable entry transition body 210. In this example, the flanges 225 are configured to engage the cassette base 120 of the cassette 100 at the opening 130 of the cassette base 120. The optical fibers 12 enter the cable entry transition body 210 at a fiber receiving portion, for example, an opening, 230. In some embodiments, an outer sheath of the cable 10 enters the opening 230. In other embodiments, the optical fibers 12 enter the opening 230 without the outer sheath. FIG. 4 shows the boot 300 before it is moved to a position adjacent to the cable entry transition body 210. In this example the boot 300 is configured to engage a ferrule 301 such that the boot 300 is held in position adjacent to the cable entry transition body 210 by a friction fit with the ferrule 301. In embodiments, a clip or other feature holds the boot 300 in position on the ferrule 301 instead of, or in addition to, the friction fit.

FIG. 4 shows the cable entry transition cover 250 having, in this example, four engagement portions, for example, clips, 255 that engage the cable entry transition body 210 to secure the cable entry transition cover 250 in place on the cable entry transition body 210. Other examples include fewer or more engagement portions. FIG. 4 shows the guide 500 having a plurality of furcation tubes 520, 521, 522 extending from the guide 500. The furcation tubes 520, 521, 522 are configured to receive the optical fibers 12 from the cable 10. Some embodiments do not include the furcation tubes 520, 521, 522.

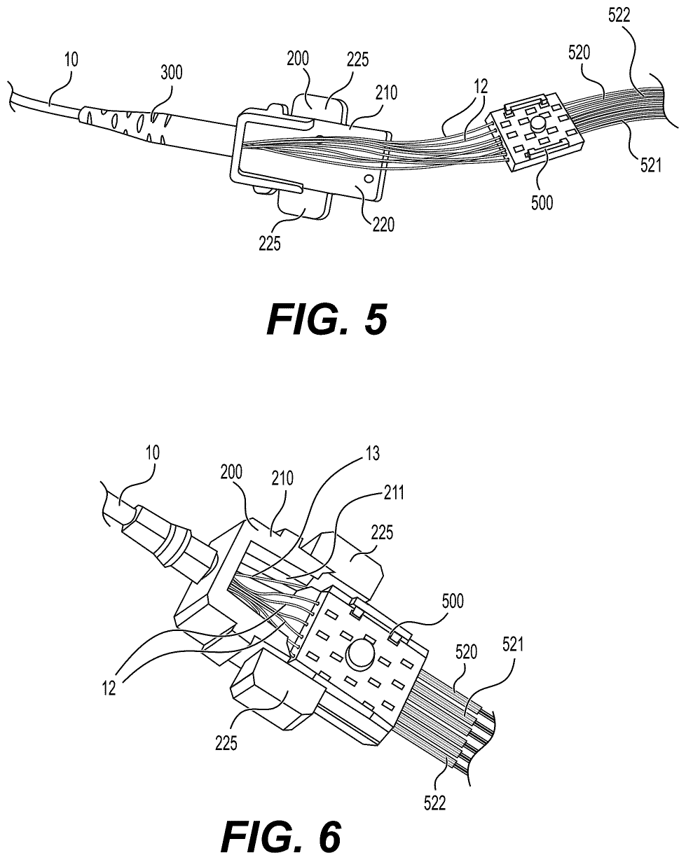

FIG. 5 shows the cable entry transition body 210 with the optical fibers 12 extending through the cable entry transition body 210, through the guide 500, and into the furcation tubes 520, 521, 522. In FIG. 5, the guide 500 is not engaged with the cable entry transition body 210. The boot 300 is shown in FIG. 5 in position over the ferrule 301. FIG. 6 shows the guide 500 engaged with the cable entry transition body 210. In this example, the guide 500 snaps into engagement with the cable entry transition body 210. Also shown in FIG. 6 is a strength member 13 (such as, for example, a Kevlar strength member) that is a part of cable 10. In embodiments, the strength member 13 is secured to a securing portion 211 in the cable entry transition body 210 of the cable entry transition 200. In embodiments, the securing portion 211 is a clip, a screw, or other feature that secures the strength member 13 to the cable entry transition body 210 such that a pulling force applied to the cable 10 is transferred to the cable entry transition body 210 by the strength member 13 and not to the optical fibers 12.

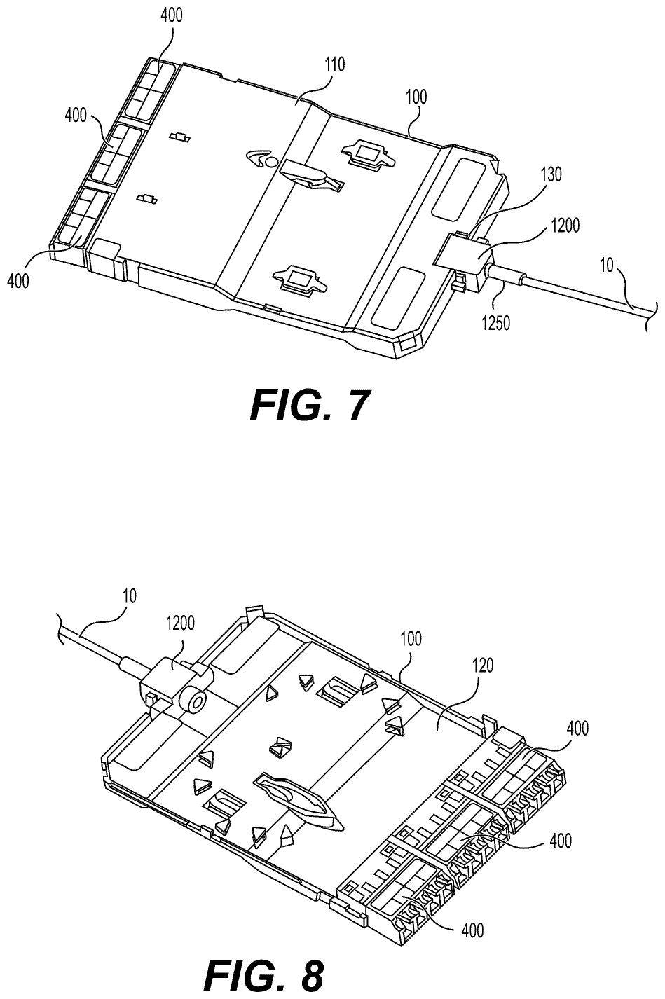

FIGS. 7-13 shows a second embodiment of the disclosure in which a cable entry transition portion, for example, a cable entry transition, 1200 is formed by low pressure molding (LPM) around the cable 10 and the optical fibers 12 in the cable 10. In embodiments, the cable entry transition 1200 is configured to be received in a receptacle that is configured to receive a standard MPO adapter.

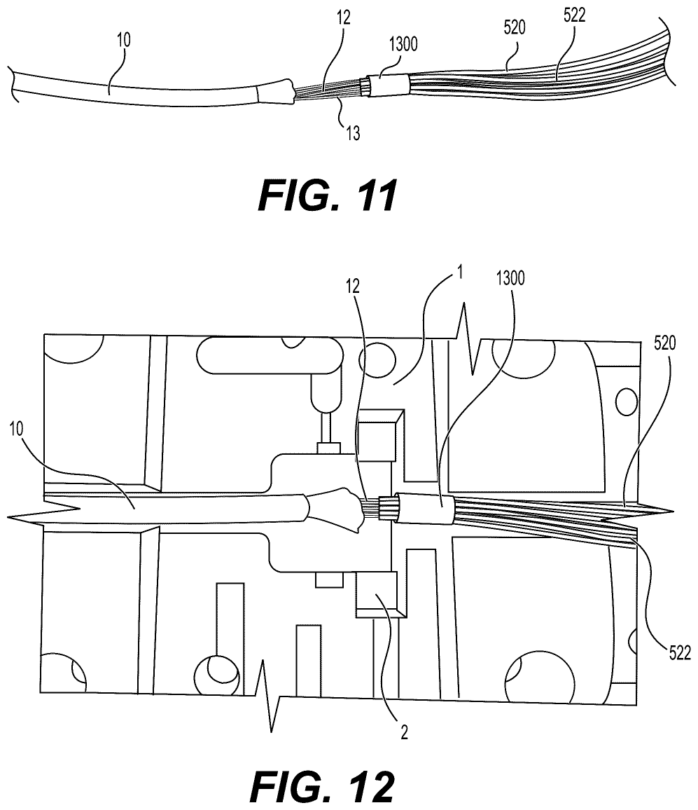

FIGS. 7 and 8 show the cassette 100 having the cassette base 120 and the cassette cover 110 that, in this example, snaps onto the cassette base 120 to cover the internal area 125 of the cassette base 120. In this example, three of the adapters 400 are located partially inside the cassette 100 and extend out of the cassette 100 at one end of the cassette 100. Other examples have fewer or more adapters 400. In this example, each of the adapters 400 is configured to receive four connectors that each connect one or more optical fibers to the adapter 400. Other examples include one or more of the adapters 400 that are configured to receive fewer or more than four connectors. FIGS. 7 and 8 show the cable 10 attached to the cassette 100 by way of the cable entry transition 1200 at the opening 130 located at an end of the cassette 100 that is opposite to the end of the cassette 100 where the adapters 400 are located. The cable 10 includes one or more optical fibers 12 (see FIG. 11). In this example, a bend-limiting strain relief portion, for example, a boot, 1250 is integrally formed as a part of the cable entry transition 1200 and is located around the cable 10 where the cable 10 enters the cable entry transition 1200 to limit bending of the cable 10 so as to prevent degradation of the optical signals transmitted in the cable 10.

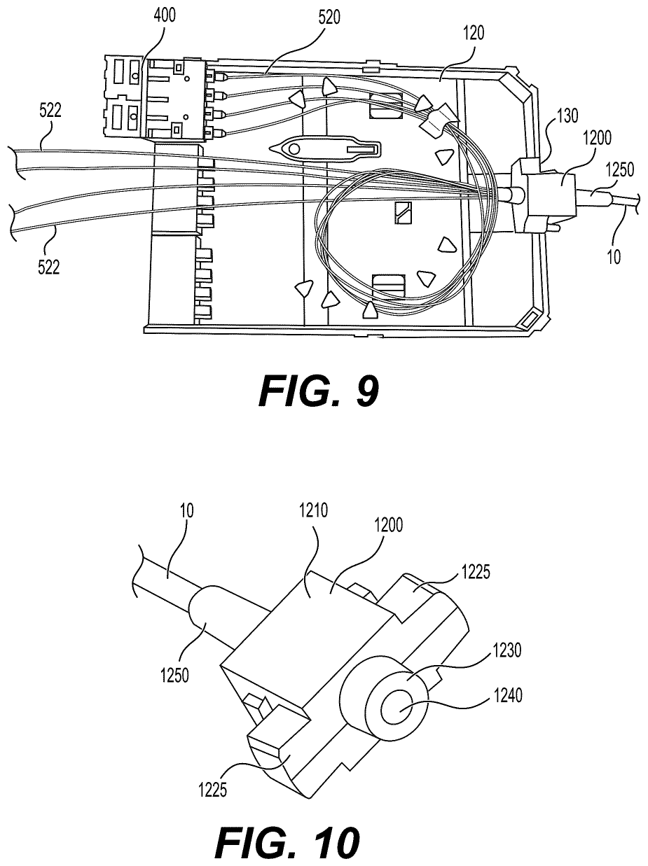

FIG. 9 shows an example of the cassette 100 that has the cable 10 entering the right side of the figure and containing a number of optical fibers. The optical fibers in this example include two groups of fibers that pass through the cable entry transition 1200. A first group of the optical fibers (in this example shown in furcation tubes 520) are connected to one of the adapters 400, and a second group of the optical fibers (in this example shown in furcation tubes 522) pass through the cassette 100. In other examples, zero, two, or more groups of the fibers pass through the cassette 100 without being connected to an adapter 400.

FIG. 10 shows the cable entry transition 1200 separate from the cassette 100. In this example, the cable entry transition 1200 has a cable entry transition main body 1210 and, in this example, two extension portions, for example, flanges, 1225 that extend laterally from a central portion of the cable entry transition main body 1210. In this example, the flanges 1225 are configured to engage the cassette base 120 of the cassette 100 at the opening 130 of the cassette base 120. In this example, the cable entry transition 1200 has a bend-limiting portion 1250 located around the cable 10 where the cable 10 attaches to the cable entry transition 1200 to limit bending of the cable 10 so as to prevent degradation of the optical signals transmitted in the cable 10. In this example, the cable entry transition 1200 has an extension portion, for example, an extension, 1230 and an opening 1240. The opening 1240 is formed by the material of the cable entry transition 1200 being formed around the optical fibers 12 of the cable 10, as described below.

FIG. 11 shows an assembly including the cable 10 with a portion of an outer sheath of the cable 10 stripped from around the optical fibers 12. FIG. 11 shows the furcation tubes 520, 522 being held together by a cylindrical retainer portion 1300 and the optical fibers 12 extending through the furcation tubes 520, 522. Also shown in FIG. 11 is the strength member 13 (such as, for example, a Kevlar strength member) that is a part of cable 10. In embodiments, the strength member 13 is secured to, for example, the retainer portion 1300 as a securing portion. In embodiments, the securing portion secures the strength member 13 to the cable entry transition main body 1210 such that a pulling force applied to the cable 10 is transferred to the cable entry transition main body 1210 by the strength member 13 and not to the optical fibers 12.

FIG. 12 shows the assembly shown in FIG. 11 positioned in a first portion 1 of a mold in preparation for low pressure molding of the cable entry transition 1200. A cavity 2 is shown that will form the cable entry transition main body 1210, the flanges 1225, the bend-limiting portion 1250, and the extension 1230. A second portion of the mold (not shown) having a similar cavity is positioned adjacent to the first portion 1 of the mold prior to injection of the molding material into the mold. Non-limiting examples of the molding material are rubber, silicone, and other flexible or rigid materials.

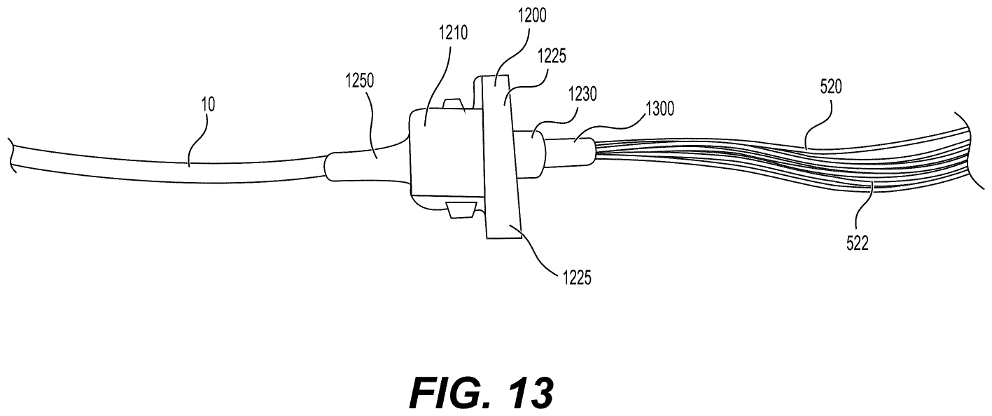

FIG. 13 shows an example of the LPM cable entry transition 1200 formed around the cable 10, the optical fibers 12, and the furcation tubes 250, 522.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A cable entry transition to a cassette for a fiber optic cable that is configured to reduce stress on an optical fiber and reduce signal loss comprising:
a cable comprising an optical fiber portion;
a cable entry transition portion comprising
a body portion that is configured to receive the cable;
a retaining portion that is configured to engage a receiving portion of a cassette;
a strength member securing portion;
a guide portion configured to connect to the body portion;
a bend-limiting portion that is structurally configured to limit a bend angle of the cable;
wherein the cable comprises a strength member portion;
wherein the strength member securing portion is configured to secure the strength member portion to the body portion;
wherein the guide portion comprises a through hole configured to receive the optical fiber portion such that the optical fiber portion passes through the guide portion intact; and
wherein the cable entry transition portion is structurally configured to mechanically secure the strength member portion of the cable to a cassette such that a pulling force exerted on the cable is prevented from being transmitted to the optical fiber portion of the cable and the optical fiber portion is allowed to pass through the cassette without using a multi-fiber push-on adapter so as to eliminate a multi-fiber push-on connection point and reduce signal loss of the system.

2. The cable arrangement of claim 1, wherein the optical fiber is a first optical fiber, and the cable further comprises a plurality of optical fibers.

3. The cable arrangement of claim 1, wherein the cable entry transition portion is structurally configured to mechanically secure the strength member in the cable to a cassette that is configured to receive an adapter.

4. The cable arrangement of claim 3, wherein the optical fiber is a first optical fiber, and the cable further comprises a second optical fiber;
wherein the first optical fiber is configured to extend from the cable to the adapter; and
wherein the second optical fiber is configured to extend through the cassette and exist the cassette.

5. The cable arrangement of claim 1, wherein the guide portion is structurally configured to receive a furcation tube, wherein the furcation tube is configured to receive the optical fiber such that the optical fiber passes through the furcation tube.

6. The cable arrangement of claim 1, wherein the strength member comprises a strength material.

7. The cable arrangement of claim 6, wherein the strength material is Kevlar.

8. The cable arrangement of claim 1, wherein the retaining portion comprises two flanges that extend laterally from a central portion of the body portion.

9. The cable arrangement of claim 1, wherein the receiving portion of the cassette is an opening.

10. The cable entry transition of claim 1, wherein the body portion, the retaining portion, the strength member securing portion, the retainer portion, and the bend-limiting portion are a homogeneously formed unit.

11. The cable entry transition of claim 1, wherein the cable entry transition is structurally configured to be received in the receiving portion of the cassette that is structurally configured to receive a standard multi-fiber push-on adapter.

12. A cable entry transition to a cassette for a fiber optic cable that is configured to reduce stress on an optical fiber and reduce signal loss comprising:
a body portion that is configured to receive a cable;
a retaining portion that is configured to engage a receiving portion of a cassette;
a strength member securing portion;
a guide portion configured to connect to the body portion;
wherein the cable comprises an optical fiber portion and a strength member portion;
wherein the strength member securing portion is configured to secure the strength member portion to the body portion;
wherein the guide portion comprises a through hole configured to receive the optical fiber portion such that the optical fiber portion passes through the guide portion intact; and
wherein the cable entry transition portion is structurally configured to mechanically secure the strength member portion of the cable to a cassette such that a pulling force exerted on the cable is prevented from being transmitted to the optical fiber portion of the cable and the optical fiber portion is permitted to pass through the cassette without using a multi-fiber push-on adapter so as to eliminate a multi-fiber push-on connection point and reduce signal loss of the system.

13. The cable entry transition portion of claim 12, wherein the cable entry transition portion is structurally configured to mechanically secure the strength member in the cable to a cassette that is configured to receive an adapter.

14. The cable entry transition portion of claim 12, wherein the guide portion is structurally configured to receive a furcation tube, wherein the furcation tube is configured to receive the optical fiber such that the optical fiber passes through the furcation tube.

15. The cable entry transition portion of claim 12, wherein the retaining portion comprises two flanges that extend laterally from a central portion of the body portion.

16. The cable entry transition portion of claim 12, wherein the cable entry transition portion further comprises a bend-limiting portion that is structurally configured to limit a bend angle of the cable.

17. The cable entry transition of claim 12, wherein the cable entry transition is structurally configured to be received in the receiving portion of the cassette that is structurally configured to receive a standard multi-fiber push-on adapter.

18. A cable entry transition portion to a cassette for a fiber optic cable that is configured to reduce stress on an optical fiber and reduce signal loss comprising:
a body portion that is configured to receive a cable;
a retaining portion that is configured to engage a receiving portion of a cassette;
a strength member securing portion;
a guide portion configured to connect to the body portion;
wherein the strength member securing portion is configured to secure a strength member portion of the cable to the body portion; and
wherein the cable entry transition portion is structurally configured to mechanically secure the strength member portion of the cable to a cassette such that a pulling force exerted on the cable is prevented from being transmitted to an optical fiber portion in the cable and the optical fiber portion is permitted to pass through the cassette so as to reduce signal loss of the system.

19. The cable entry transition portion of claim 18, wherein the guide portion comprises a through hole configured to receive the optical fiber such that the optical fiber passes through the guide portion intact.

20. The cable entry transition portion of claim 18, wherein the cable entry transition portion further comprises a bend-limiting portion that is structurally configured to limit a bend angle of the cable.

21. The cable entry transition portion of claim 18, wherein the cable entry transition portion is structurally configured to mechanically secure the strength member in the cable to the cassette to prevent a pulling force exerted on the cable from being transmitted to an optical fiber in the cable while allowing the optical fiber to pass through the cassette, without using a multi-fiber push on adapter, thereby eliminating a multi-fiber push on connection point.

22. The cable entry transition portion of claim 18, wherein the cable entry transition portion is structurally configured to mechanically secure the strength member in the cable to a cassette that is configured to receive an adapter.

23. The cable entry transition portion of claim 18, wherein the guide portion is structurally configured to receive a furcation tube, wherein the furcation tube is configured to receive the optical fiber such that the optical fiber passes through the furcation tube.

24. The cable entry transition portion of claim 18, wherein the retaining portion comprises two flanges that extend laterally from a central portion of the body portion.

25. The cable entry transition portion of claim 18, wherein the cable entry transition portion is structurally configured to be received in the receiving portion of the cassette that is structurally configured to receive a standard multi-fiber push-on adapter.
